(19) United States
(12) Patent Application Publication
(10) Pub. No.: US 2022/0144683 A1
(43) Pub. Date: May 12, 2022

(54) APPARATUS FOR MANUFACTURING A GLASS RIBBON

(71) Applicant: Corning Incorporated, Corning, NY (US)

(72) Inventors: Jung Ho Ko, Chungcheongnam-do (KR); Doohee Seok, Chungcheongnam-do (KR)

(21) Appl. No.: 17/611,599

(22) PCT Filed: May 11, 2020
(86) PCT No.: PCT/US2020/032287

§ 371 Date: Nov. 16, 2021

(30) Foreign Application Priority Data
May 16, 2019 (KR) 10-2019-0057530

(51) Int. Cl. C03B 33/02; C03B 17/06; C03B 33/027; C03B 33/033

(52) U.S. Cl. CPC C03B 33/0215; C03B 17/064; C03B 17/068; C03B 33/033; C03B 33/027

(57) ABSTRACT

Apparatus for manufacturing glass including a forming body configured to form a glass ribbon and a glass scoring apparatus positioned below the forming body. The glass scoring apparatus includes a frame, a cross-member assembly and a movable scoring unit coupled thereto. At least four drive assemblies are mounted on the frame, each drive assembly including a threaded shaft, a drive motor coupled to the threaded shaft and configured to rotate the threaded shaft, and a ball nut assembly engaged with threads of the threaded shaft and coupled to the cross-member assembly such that rotation of the threaded shafts by the drive motors causes the cross-member assembly to vertically rise or lower. Multiple scoring devices are provided to enable bidirectional scoring of the glass ribbon.

### CROSS-REFERENCE TO RELATED APPLICATIONS

This application claims the benefit of priority of Korean Patent Application Serial No. 10-2019-0057530 filed on May 16, 2019 the contents of which are relied upon and incorporated herein by reference in their entirety as if fully set forth below.

### BACKGROUND

### Field

The present disclosure relates to an apparatus for manufacturing a glass ribbon, and more particularly an apparatus for bidirectional scoring of a glass ribbon drawn from a forming body.

### Technical Background

It is known to draw a glass ribbon in a downdraw process, such as, for example, a fusion downdraw process. Cutting the glass ribbon into glass sheets can be done by synchronizing a glass cutting apparatus with the downward travel of the glass ribbon as the glass ribbon is drawn from a forming body. Travel of the glass cutting apparatus with the glass ribbon, and its return, and manipulation of the cutting device, e.g., travel of the cutting device across the glass ribbon, can become a significant bottleneck in the drawing process. For example, conventional cutting devices are typically unidirectional and therefore score in one direction, then return to an initial position before making the next score. As a result, the scoring device traverses the glass ribbon twice to complete a single scoring operation.

What is needed are improvements to the scoring operation that reduce cycle time, and reduce unnecessary wear on the scoring apparatus components.

### SUMMARY

In accordance with the present disclosure, a glass manufacturing apparatus is disclosed comprising a forming body configured to form a glass ribbon and a glass scoring apparatus positioned below the forming body. The glass scoring apparatus can comprise a frame, a cross-member assembly, and at least four drive assemblies mounted on the frame. Each drive assembly of the four drive assemblies can comprise a threaded shaft, a dedicated drive motor coupled to the threaded shaft and configured to rotate the threaded shaft, and a ball nut assembly engaged with the threaded shaft and coupled to the cross-member assembly.

Each drive motor can be coupled to the respective threaded shaft by a reducing gear assembly. In some embodiments, a reduction ratio of the reducing gear assemblies can be in a range from 4:1 to 2:1.

In various embodiments, the cross-member assembly can comprise a first end and a second end opposite the first end, wherein two ball nut assemblies are attached to the cross-member assembly at the first end and two ball nut assemblies are attached to the cross-member assembly at the second end.

The cross-member assembly may further comprise a scoring unit movably coupled thereto. For example, the scoring unit can comprise a first unidirectional scoring device coupled to a first actuator by a first articulated linkage arranged to move the first scoring device from an engaged position wherein the first scoring device contacts the glass ribbon to a disengaged position wherein the first scoring device is removed from the glass ribbon. The first unidirectional scoring device can be configured to produce a first score line when traversed in a first scoring direction while in the engaged position.

In various embodiments, the scoring unit may further comprise a second unidirectional scoring device coupled to a second actuator by a second articulated linkage arranged to move the second scoring device from an engaged position wherein the second scoring device contacts the glass ribbon to a disengaged position wherein the second scoring device is removed from the glass ribbon. The second scoring device can be configured to produce a second score line while in the engaged position and traversed in a second scoring direction opposite the first scoring direction.

In other embodiments, a glass manufacturing apparatus is described comprising a forming body configured to form a glass ribbon, and a glass scoring apparatus positioned below the forming body. The glass scoring apparatus can comprise a frame and a cross-member assembly comprising a movable scoring unit. The movable scoring unit can comprise a first scoring device configured to score the glass ribbon in a first scoring direction, and a second scoring device configured to score the glass ribbon in a second scoring direction opposite the first scoring direction.

The glass manufacturing apparatus may further comprise at least four drive assemblies mounted on the frame, each drive assembly of the four drive assemblies comprising a threaded shaft, a dedicated drive motor coupled to the threaded shaft and configured to rotate the threaded shaft, and a ball nut assembly engaged with the threaded shaft and coupled to the cross-member assembly.

Each dedicated drive motor of the four drive assemblies can be coupled to the respective threaded shaft by a reducing gear assembly. In some embodiments, a reduction ratio of each reducing gear assembly of the four drive assemblies can be in a range from 4:1 to 2:1.

The first scoring device can be coupled to a first articulated linkage and the second scoring can be coupled to a second articulated linkage.

In still other embodiments, a method of manufacturing a glass sheet is disclosed comprising drawing a glass ribbon from a forming body, the glass ribbon extending adjacent a cross-member assembly in a draw direction at a draw speed V. The cross-member assembly can comprise a movable scoring unit coupled thereto, the scoring unit comprising a first scoring device and a second scoring device. The method may comprise moving the cross-member assembly from a first vertical position in the draw direction at the draw speed V and forming a first score line in the glass ribbon, the forming the first score line comprising engaging the first scoring device with the glass ribbon and moving the scoring unit in a first scoring direction. The method may further comprise removing a first glass sheet from the glass ribbon below the first score line and forming a second score line in the glass ribbon above the first score line, the forming the second score line comprising engaging the second scoring device with the glass ribbon and moving the scoring unit in a second scoring direction opposite the first scoring direction. The method may still further comprise removing a second glass sheet from the glass ribbon below the second score line.

In some embodiments, the method may comprise moving the cross-member assembly back to the first vertical position after the removing the first glass sheet and before the forming the second score line.

In some embodiments, the forming the first score line can comprise moving the scoring unit in the first scoring direction from a first initial position to a first start position spaced apart from the first initial position, engaging the glass ribbon with the first scoring device from the first start position, and moving the scoring unit in the first scoring direction to a first stop position spaced apart from the first start position.

The method may still further comprise, stopping the scoring unit at the first stop position, disengaging the first scoring device from the glass ribbon at the first stop position, and moving the scoring unit in the first scoring direction from the first stop position to a second initial position spaced apart from the first stop position.

In various embodiments, the forming the second score line can comprise moving the scoring unit in the second scoring direction from the second initial position to a second start position spaced apart from the second initial position, engaging the glass ribbon with the second scoring device from the second start position, and moving the scoring unit in the second scoring direction to a second stop position spaced apart from the second start position.

The method may still further comprise, stopping the scoring unit at the second stop position, disengaging the second scoring device from the glass ribbon at the second stop position, and moving the scoring unit in the second scoring direction from the second stop position to the first initial position.

In various embodiments, the moving the cross-member assembly back to the first vertical position can comprise moving the cross-member assembly at a speed greater than V.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of an exemplary glass manufacturing apparatus according to various embodiments described herein;

FIG. 2 is an elevational view of an exemplary glass cutting apparatus according to embodiments described herein;

FIG. 3 is a top view of a portion of the glass cutting apparatus of FIG. 2;

FIG. 4 is a top view of an exemplary cross-member assembly according to embodiments described herein;

FIG. 5 is a side view of an exemplary scoring device; and

FIG. 6 is a top view of an exemplary scoring unit.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented, but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

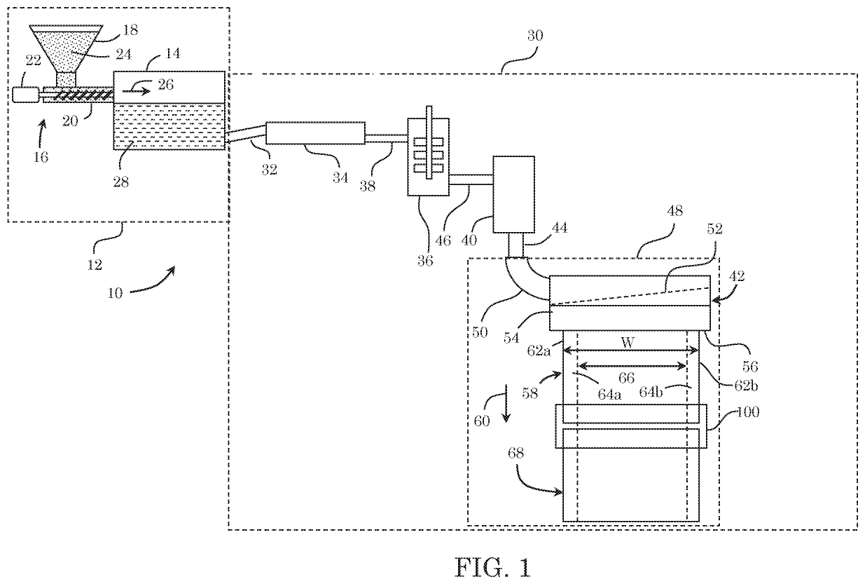

Shown in FIG. 1 is an exemplary glass manufacturing apparatus 10. In some embodiments, the glass manufacturing apparatus 10 can comprise a glass melting furnace 12 including a melting vessel 14. In addition to melting vessel 14, glass melting furnace 12 can optionally include one or more additional components such as heating elements (e.g., combustion burners and/or electrodes) configured to heat raw material and convert the raw material into molten glass. For example, melting vessel 14 may be an electrically-boosted melting vessel, wherein energy is added to the raw material through both combustion burners and by direct heating, wherein an electrical current is passed through the raw material, the electrical current thereby adding energy via Joule heating of the raw material.

In further embodiments, glass melting furnace 12 can include other thermal management devices (e.g., insulation components) that reduce heat loss from the melting vessel. In still further embodiments, glass melting furnace 12 can include electronic and/or electromechanical devices that facilitate melting of the raw material into a glass melt. Glass melting furnace 12 can include support structures (e.g., support chassis, support member, etc.) or other components.

Melting vessel 14 can be formed from a refractory material, such as a refractory ceramic material, for example a refractory ceramic material comprising alumina or zirconia, although the refractory ceramic material can comprise other refractory materials, such as yttrium (e.g., yttria, yttria-stabilized zirconia, yttrium phosphate), zircon (ZrSiO₄) or alumina-zirconia-silica or even chrome oxide, used either alternatively or in any combination. In some examples, melting vessel 14 may be constructed from refractory ceramic bricks.

In some embodiments, glass melting furnace 12 can be incorporated as a component of a glass manufacturing apparatus configured to fabricate a glass article, for example a glass ribbon, although in further embodiments, the glass manufacturing apparatus can be configured to form other glass articles without limitation, such as glass rods, glass tubes, glass envelopes (for example, glass envelopes for lighting devices, e.g., light bulbs) and glass lenses, although many other glass articles are contemplated. In some examples, the melting furnace may be included in a glass manufacturing apparatus comprising a slot draw apparatus, a float bath apparatus, a down-draw apparatus (e.g., a fusion down draw apparatus), an up-draw apparatus, a pressing apparatus, a rolling apparatus, a tube drawing apparatus or any other glass manufacturing apparatus that would benefit from the present disclosure. By way of example, FIG. 1 schematically illustrates glass melting furnace 12 as a component of a fusion down-draw style glass manufacturing apparatus 10 for fusion drawing a glass ribbon for subsequent processing into individual glass sheets or rolling the glass ribbon onto a spool.

Glass manufacturing apparatus 10 can optionally include an upstream glass manufacturing apparatus 16 positioned upstream of melting vessel 14. In some examples, a portion of, or the entire upstream glass manufacturing apparatus 16, can be incorporated as part of the glass melting furnace 12.

As shown in the embodiment illustrated in FIG. 1, upstream glass manufacturing apparatus 16 can include a raw material storage bin 18, a raw material delivery device 20 and a motor 22 connected to raw material delivery device 20. Raw material storage bin 18 can be configured to store a quantity of raw material 24 that can be fed into melting vessel 14 of glass melting furnace 12 through one or more feed ports, as indicated by arrow 26. Raw material 24 typically comprises one or more glass forming metal oxides and one or more modifying agents. In some examples, raw material delivery device 20 can be powered by motor 22 to deliver a predetermined amount of raw material 24 from raw material storage bin 18 to melting vessel 14. In further examples, motor 22 can power raw material delivery device 20 to introduce raw material 24 at a controlled rate based on a level of molten glass sensed downstream from melting vessel 14 relative to a flow direction of the molten glass. Raw material 24 within melting vessel 14 can thereafter be heated to form molten glass 28. Typically, in an initial melting step, raw material is added to the melting vessel as particulate, for example as various “sands”. Raw material 24 can also include scrap glass (i.e. cullet) from previous melting and/or forming operations. Combustion burners are typically used to begin the melting process. In an electrically boosted melting process, once the electrical resistance of the raw material is sufficiently reduced, electric boost can begin by developing an electrical potential between electrodes positioned in contact with the raw material, thereby establishing an electrical current through the raw material, the raw material typically entering, or in, a molten state.

Glass manufacturing apparatus 10 can also optionally include a downstream glass manufacturing apparatus 30 positioned downstream of glass melting furnace 12 relative to a flow direction of molten glass 28. In some examples, a portion of downstream glass manufacturing apparatus 30 may be incorporated as part of glass melting furnace 12. However, in some instances, first connecting conduit 32 discussed below, or other portions of the downstream glass manufacturing apparatus 30, can be incorporated as part of the glass melting furnace 12.

Downstream glass manufacturing apparatus 30 can include a first conditioning (i.e. processing) chamber, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may drive molten glass 28 through an interior pathway of first connecting conduit 32 from melting vessel 14 to fining vessel 34. Accordingly, first connecting conduit 32 provides a flow path for molten glass 28 from melting vessel 14 to fining vessel 34. It should be understood, however, that other conditioning chambers may be positioned downstream of melting vessel 14, for example between melting vessel 14 and fining vessel 34. In some embodiments, a conditioning chamber can be employed between the melting vessel and the fining chamber. For example, molten glass from a primary melting vessel can be further heated in a secondary melting (conditioning) vessel, or cooled in the secondary melting vessel to a temperature lower than the temperature of the molten glass in the primary melting vessel before entering the fining chamber.

As described previously, bubbles may be removed from molten glass 28 by various techniques. For example, raw material 24 may include multivalent compounds (i.e. fining agents) such as tin oxide that, when heated, undergo a chemical reduction reaction and release oxygen. Other suitable fining agents include without limitation arsenic, antimony, iron and cerium, although the use of arsenic and antimony may be discouraged for environmental reasons in some applications. Fining vessel 34 is heated, for example to a temperature greater than the melting vessel temperature, thereby heating the fining agent. Oxygen produced by the temperature-induced chemical reduction of one or more fining agents included in the molten glass diffuse into bubbles produced during the melting process. The enlarged gas bubbles with increased buoyancy can then rise to a free surface of the molten glass within the fining vessel and thereafter be vented out of the fining vessel.

The downstream glass manufacturing apparatus 30 can further include another conditioning chamber, such as mixing apparatus 36, for example a stirring vessel, for mixing the molten glass that flows downstream from fining vessel 34. Mixing apparatus 36 can be used to provide a homogenous glass melt composition, thereby reducing chemical or thermal inhomogeneities that may otherwise exist within the molten glass exiting the fining chamber. As shown, fining vessel 34 may be coupled to mixing apparatus 36 by way of a second connecting conduit 38. In some embodiments, molten glass 28 can be gravity fed from the fining vessel 34 to mixing apparatus 36 by way of second connecting conduit 38. For instance, gravity may drive molten glass 28 through an interior pathway of second connecting conduit 38 from fining vessel 34 to mixing apparatus 36. Typically, the molten glass within mixing apparatus 36 includes a free surface, with a free volume extending between the free surface and a top of the mixing apparatus. While mixing apparatus 36 is shown downstream of fining vessel 34 relative to a flow direction of the molten glass, mixing apparatus 36 may be positioned upstream from fining vessel 34 in other embodiments. In some embodiments, downstream glass manufacturing apparatus 30 may include multiple mixing apparatus, for example a mixing apparatus upstream from fining vessel 34 and a mixing apparatus downstream from fining vessel 34. These multiple mixing apparatus may be of the same design, or they may be of a different design from one another. In some embodiments, one or more of the vessels and/or conduits can include static mixing vanes positioned therein to promote mixing and subsequent homogenization of the molten material.

Downstream glass manufacturing apparatus 30 can further include another conditioning chamber such as delivery vessel 40 located downstream from mixing apparatus 36. Delivery vessel 40 can condition molten glass 28 to be fed into a downstream forming device. For instance, delivery vessel 40 can act as an accumulator and/or flow controller to adjust and provide a consistent flow of molten glass 28 to forming body 42 by way of exit conduit 44. The molten glass within delivery vessel 40 can, in some embodiments, include a free surface, wherein a free volume extends upward from the free surface to a top of the delivery chamber. As shown, mixing apparatus 36 can be coupled to delivery vessel 40 by way of third connecting conduit 46. In some examples, molten glass 28 can be gravity fed from mixing apparatus 36 to delivery vessel 40 by way of third connecting conduit 46. For instance, gravity can drive molten glass 28 through an interior pathway of third connecting conduit 46 from mixing apparatus 36 to delivery vessel 40.

Downstream glass manufacturing apparatus 30 can further include forming apparatus 48 comprising the above-referenced forming body 42, including inlet conduit 50. Exit conduit 44 can be positioned to deliver molten glass 28 from delivery vessel 40 to inlet conduit 50 of forming apparatus 48. Forming body 42 in a fusion down-draw glass making apparatus can comprise a trough 52 positioned in an upper surface of the forming body, and converging forming surfaces 54 (only one surface shown) that converge in a draw direction along a bottom edge (root) 56 of the forming body. Molten glass delivered to forming body trough 52 via delivery vessel 40, exit conduit 44 and inlet conduit 50 overflows the walls of trough 52 and descends along the converging forming surfaces 54 as separate flows of molten glass. The separate flows of molten glass join below and along the root 56 to produce a single ribbon 58 of molten glass that is drawn along a draw plane in a draw direction 60 from root 56 by applying a downward tension to the glass ribbon, such as by gravity and/or pulling roll assemblies (not shown), to control the dimensions of the glass ribbon as the molten glass cools and a viscosity of the material increases. Accordingly, glass ribbon 58 goes through a visco-elastic transition to an elastic state and acquires mechanical properties that give glass ribbon 58 stable dimensional characteristics. Glass ribbon 58 comprises first outer edges 62a and second outer edge 62b opposite first outer edge 62a, the first and second outer edges extending lengthwise along glass ribbon 58. Glass ribbon 58 may further comprise first thickened edge portion 64a and second thickened edge portion 64b (hereinafter first bead 64a and second bead 64b, respectively), beads 64a, 64b extending inward from respective first and second outer edges 62a, 62b. Glass ribbon 58 comprises a width W defined between first and second outer edges 62a and 62b. First and second beads 64a, 64b can comprise a thickness greater than a thickness of the glass ribbon along a longitudinal centerline of the glass ribbon. The glass ribbon extending between first bead 64a and second bead 64b can be referred to as the “quality” region 66 of the glass ribbon. Quality region 66 exhibits a substantially uniform thickness and pristine surfaces, and is the most commercially valuable portion of the ribbon, as the beads are typically removed and used as cullet, or scrapped. Glass ribbon 58 may, in some embodiments, be separated into individual glass sheets 68 by a glass separation apparatus 100, although in further embodiments, the glass ribbon 58 may be wound onto spools and stored for further processing.

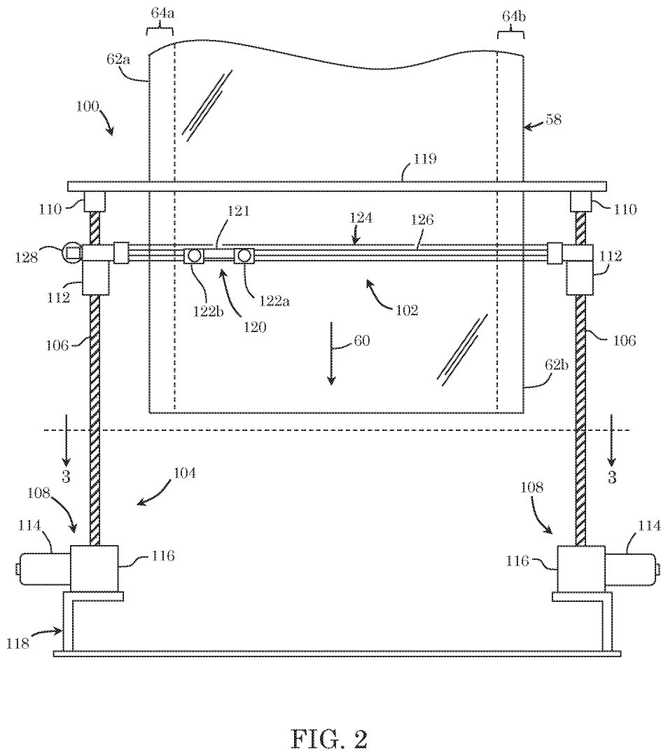

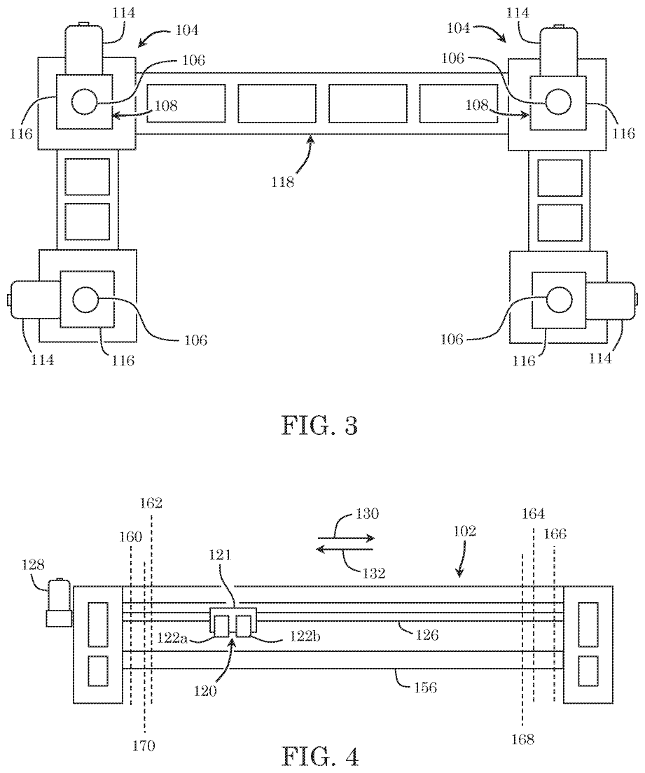

As shown in FIGS. 2 and 3, glass separation apparatus 100 is provided to cut glass ribbon in a widthwise direction (orthogonal to draw direction 60) and form glass sheets 68. Glass separation apparatus 100 can comprise a cross-member assembly 102 supported by a plurality of drive assemblies 104. Each drive assembly 104 of the plurality of drive assemblies can comprise a threaded shaft 106 coupled to a drive unit 108 at one end of the threaded shaft and a support bearing 110 at an opposing end of the threaded shaft. In addition, a ball nut assembly 112 can be coupled to each threaded shaft 106, and each ball nut assembly 112 can be coupled to cross-member assembly 102. For example, in various embodiments, glass separation apparatus 100 may comprise a generally rectangular and elongate cross-member assembly 102 including two opposing ends and four corners, two corners at each end. Accordingly, in various embodiments, glass separation apparatus 100 can comprise at least four drive assemblies 104, one drive assembly at or near each corner of cross-member assembly 102, although placement at corners is not required, and in further embodiments, the drive assemblies may be placed at other locations on cross member assembly 102.

Each drive unit 108 can comprise a drive motor 114 and a reduction gear assembly 116 that couples the drive motor 114 to the threaded shaft 106. Each drive motor 114 comprising drive units 108 is a dedicated drive motor. As used herein, a dedicated drive motor refers to a drive motor dedicated to a single threaded shaft 106 (drives a single threaded shaft 106) and does not drive other threaded shafts. Accordingly, if there are, for example, four drive units 108, there are four drive motors 114 coupled to four threaded shafts 106 by four reduction gear assemblies 116. A reduction ratio of the reduction gear assemblies 116 can be less than 5:1, for example, in a range from about 4:1 to about 2:1, such as about 3.5:1. A reduction ratio less than 5:1 provided by reduction gear assemblies 116 and/or dedicated drive motors 114 can reduce the load borne by each drive assembly 104 during operation of the drive assemblies. Thus, in such embodiments, smaller motors may be used, component lifetimes may be improved, and vertical traverse speed of cross-member assembly 102 may be increased, especially during an upward traverse, thereby improving cycle time.

Drive units 108 can be supported by lower frame 118. Lower frame 118 may be any suitable rigid support capable of supporting the weight of glass separation apparatus 100. For example, lower frame 118 may be attached to building girders, concrete flooring, or other suitable structural members of the building. In other embodiments, lower frame 118 can be a stand-alone structure. Glass separation apparatus 100 may further comprise an upper frame member 119 coupled to drive assemblies 104 at the upper ends of drive assemblies 104, for example at support bearings 110 mounted to upper frame member 119. Upper frame member 119 can provide rigidity to drive assemblies 104 and ensure uniform and consistent spacing between the drive assemblies (e.g., threaded shafts 106).

Each ball nut assembly 112 can comprise a plurality of ball bearings housed in a body, the plurality of ball bearings engaged with the threads of the threaded shafts 106 that act as raceways for the ball bearings. To wit, each drive assembly 104 may comprise a ball screw apparatus wherein each threaded shaft 106 is rotatable by a respective drive unit 108. As the threaded shaft is rotated by the respective drive unit 108, the ball nut assembly 112 travels along a length of the threaded shaft according to the direction of rotation of threaded shaft 106. Ball screw apparatus (e.g., threaded shafts and ball nut assemblies) are known in the art, and their construction will not be described further. Because cross member assembly 102 is supported on threaded shafts 106 by ball nut assemblies 112, rotation of threaded shafts 106 by their respective drive units 108 either raises or lowers cross-member assembly 102 depending on the direction of rotation of the threaded shafts.

Cross-member assembly 102 may further comprise a scoring unit 120 comprising carriage 121, first scoring device 122a, and second scoring device 122b. In various embodiments, cross-member assembly 102 may still further comprise a scoring unit drive assembly 124 comprising linear drive member 126 and drive motor 128, for example a servo-motor. In some embodiments, linear drive member 126 may comprise a belt configured as an endless loop coupled to drive motor 128 and supported by a rail member and rollers, wherein scoring unit 120 is also coupled to the belt. Drive motor 128 is configured to drive scoring unit 120 along a length of linear drive member 126. For example, linear drive member 126 may be oriented orthogonal to draw direction 60, e.g., in a horizontal orientation, although in further embodiments, linear drive member 126 can be angled relative to horizontal. Accordingly, in some embodiments, scoring unit 120 can be traversed along opposing travel directions 130, 132 orthogonal to draw direction 60 across glass ribbon 58 by scoring unit drive assembly 124.

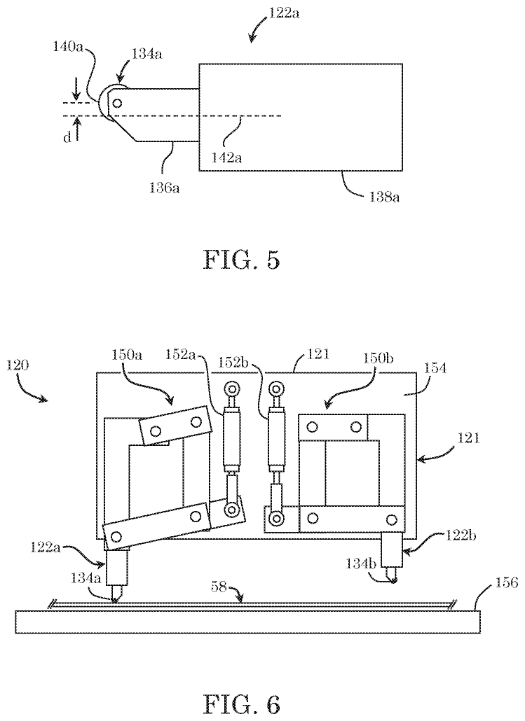

In some embodiments, scoring devices 122a, 122b can be configured to be unidirectional. That is, scoring devices 122a, 122b can be configured to score effectively during traverse in a single direction. For example, FIG. 5 illustrates an exemplary embodiment of first scoring device 122a wherein first scoring tool 134a, e.g., a scoring wheel, scoring blade, scribe or other suitable scoring tool, is coupled to a shaft 136a rotatable within body 138a. Shaft 136a can be configured to have limited ability to rotate. For example, in various embodiments, shaft 136a can be configured to rotate through an angle equal to or less than about 15 degrees, for example equal to or less than about 10 degrees, for example in a range from about 1 degree to about 15 degrees. The point of contact 140a between glass ribbon 58 and first scoring tool 134a is offset a distance d from rotational axis 142a of shaft 136a such that point of contact 140a lags rotational axis 142a relative to a direction of travel of scoring device 122a when first scoring tool 134a is in contact with glass ribbon 58 and traversing across the glass ribbon. That is, first scoring tool 134a, and shaft 136a behave as a caster assembly that stabilizes movement of first scoring tool 134a as the first scoring tool traverses across the surface of glass ribbon 58. Second scoring device 122b may be identical to first scoring device 122a, with the exception that second scoring device 122b can be configured to score in a direction opposite the scoring direction of first scoring device 12a.

Referring to FIG. 6, in some embodiments, first and second scoring devices 122a, 122b can be coupled to first and second articulated linkages 150a, 150b, respectively, first and second articulated linkages 150a, 150b comprising respective first and second actuators 152a, 152b, for example pneumatic actuators. As used herein, an articulated linkage refers to two or more members connected by a flexible (e.g., rotary) joint and that links first and second scoring devices 122a, 122b to first and second actuators 152a, 152b. First and second actuators 152a, 152b can be mounted to base plate 154 of carriage 121 at one end of the actuators, while the opposite ends of first and second actuators 152a, 152b can be coupled to respective first and second articulated linkages 150a, 150b. When activated, first and second actuators 152a, 152b, and respective first and second articulated linkages 150a, 150b, can extend or retract respective first and second scoring devices 122a, 122b away from or toward glass ribbon 58 in accordance with instructions received from a controller (not shown), for example a programmable logic controller (PLC). When first scoring device 122a or second scoring device 122b is in the extended (engaged) position, respective first scoring tool 134a or second scoring tool 134b is in contact with a major surface of glass ribbon 58. When first scoring device 122a or second scoring device 122b is in the retracted (disengaged) position, respective first scoring tool 134a or second scoring tool 134b is removed from (spaced apart from) the major surface of the glass ribbon. In the view shown in FIG. 6, first actuator 152a is shown having moved first scoring device 122a into an engaged position with first scoring tool 134a in contact with glass ribbon 58, while second actuator 152b is shown having moved second scoring device 122b into a disengaged position with second scoring tool 134b removed from glass ribbon 58. Cross-member assembly 102 may be provided with a nosing member 156 that supports a major surface of glass ribbon 58 opposite the major surface of the glass ribbon contacted by the scoring tool.

In accordance with embodiments disclosed herein, scoring unit 120 can be positioned at one edge of the glass ribbon. By way of example and not limitation, and referencing FIG. 2, glass ribbon 58 is drawn downward in draw direction 60 at a substantially constant draw speed V. Drive motors 114 rotate respective threaded shafts 106 through reduction gear assemblies 116 so that cross-member assembly 102 descends from a first vertical cross-member assembly start position at draw speed V with substantially no relative motion between cross-member assembly 102 and glass ribbon 58. In an exemplary embodiment, scoring unit 120 can be positioned at first initial position 160 at the left side of linear drive member 126. Scoring unit 120 can then be moved from first initial position 160 to a first start position 162. For example, in some embodiments, first start position 162 can be positioned spaced apart from first bead 64a relative to first outer edge 62a (between first bead 64a and second bead 64b). First actuator 152a can be activated at first start position 162, which moves first scoring device 122a from a retracted position to an extended position wherein first scoring tool 134a contacts a major surface of glass ribbon 58. From first start position 162, scoring unit 120 can be moved left-to-right along first scoring direction 130 toward the opposite end of linear drive member 126 by scoring unit drive assembly 124, thereby forming a score line across at least a portion of width W of glass ribbon 58, for example across quality region 66. As used herein, a score line refers to a line of damage (e.g., cracking, chipping, and the like) on a surface of a substrate produced by a scoring tool and extending into the substrate a predetermined depth from the scored surface. Scoring unit 120 is stopped at first stop position 164, and first actuator 152a is activated to retract first scoring device 122a, thereby removing first scoring tool 134a from glass ribbon 58. From first stop position 164, scoring unit 120 can be moved farther in first scoring direction 130 to a second initial position 166 at the right side of linear drive member 126. A robot (not shown) coupled to a bottom portion of glass ribbon 58 below the score line can be used to create a bending moment across the score line, driving a crack across the width W of glass ribbon 58 and through a thickness of the glass ribbon, thereby separating a first glass sheet 68 from glass ribbon 58.

With scoring unit 120 positioned at second initial position 166, drive assemblies 104 rotate threaded shafts 106 in a direction that moves cross-member assembly 102 vertically upwards, returning cross-member assembly 102 to the first vertical cross-member assembly position, and, after a sufficient length of glass ribbon 58 has passed, drive assemblies 104 rotate threaded shafts in a direction that moves cross-member assembly 102 vertically downwards again at draw speed V. In some embodiments, cross-member assembly 102 may be moved vertically upwards to the first vertical cross member assembly position at a speed greater than V. Scoring unit 120 can be moved to second start position 168 and second actuator 152b activated, thereby extending second scoring device 122b to an engaged position with second scoring tool 134b in contact with glass ribbon 58. In some embodiments, second start position may coincide with first stop position 164, or the second start position 168 may be different than first stop position 164, e.g., offset therefrom. Scoring unit 120 can be moved in second scoring direction 132 to second stop position 170, creating a second score line across glass ribbon 58. Scoring unit 120 can be stopped at second stop position 170 and second actuator 152b can be actuated to retract second scoring device 122b and disengage second scoring tool 134b from the surface of glass ribbon 58. Second stop position 170 can coincide with first start position 162, or second stop position 170 may be different than first start position 162, e.g., offset therefrom. Scoring unit 120 can then be moved farther in second scoring direction to first initial position 160. The robot can apply a bending moment across the second score line, driving a crack across the glass ribbon and through a thickness of the glass ribbon, thereby separating a second glass sheet 68 from glass ribbon 58. The preceding sequences can be repeated as often as needed to produce multiple glass sheets 68.

In accordance with the foregoing sequence of events, each left-to-right traverse and each right-to-left traverse of scoring unit 120 can result in a score line across at least a portion of the glass ribbon width, and production of a glass sheet from the glass ribbon. The ability to score in two directions can reduce wear on components of scoring unit drive assembly 124 and scoring devices 122a, 122b compared to conventional scoring units that must score along a first direction, e.g., first scoring direction 130, then return along second scoring direction 132 in preparation for making the next score line without scoring in the second direction. That is, in a conventional apparatus, two traverses may be needed for each score line produced, whereas in accordance with embodiments of the present disclosure, a score line can be produced with each traverse of scoring unit 120. Moreover, bidirectional scoring may further reduce cycle time and/or allow for a reduced scoring speed (traverse speed of scoring unit 120), thereby increasing the quality of separated surfaces.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A glass manufacturing apparatus, comprising:
a forming body configured to form a glass ribbon;
a glass scoring apparatus positioned below the forming body, the glass scoring apparatus comprising:
a frame;
a cross-member assembly;
at least four drive assemblies mounted on the frame, each drive assembly of the at least four drive assemblies comprising:
a threaded shaft;
a dedicated drive motor coupled to the threaded shaft and configured to rotate the threaded shaft; and
a ball nut assembly engaged with the threaded shaft and coupled to the cross-member assembly.

2. The glass manufacturing apparatus according to claim 1, wherein each dedicated drive motor is coupled to the respective threaded shaft by a reducing gear assembly.

3. The glass manufacturing apparatus according to claim 2, wherein a reduction ratio of the reducing gear assemblies is in a range from 4:1 to 2:1.

4. The glass manufacturing apparatus according to claim 1, wherein the cross-member assembly comprises a first end and a second end opposite the first end, wherein two ball nut assemblies are attached to the cross-member assembly at the first end and two ball nut assemblies are attached to the cross-member assembly at the second end.

5. The glass manufacturing apparatus according to claim 1, wherein the cross-member assembly further comprises a scoring unit movably coupled thereto.

6. The glass manufacturing apparatus according to claim 5, wherein the scoring unit comprises a first unidirectional scoring device coupled to a first actuator by a first articulated linkage arranged to move the first scoring device from an engaged position wherein the first scoring device contacts the glass ribbon to a disengaged position wherein the first scoring device is removed from the glass ribbon, the first unidirectional scoring device configured to produce a first score line when traversed in a first scoring direction while in the engaged position.

7. The glass manufacturing apparatus according to claim 6, wherein the scoring unit comprises a second unidirectional scoring device coupled to a second actuator by a second articulated linkage arranged to move the second scoring device from an engaged position wherein the second scoring device contacts the glass ribbon to a disengaged position wherein the second scoring device is removed from the glass ribbon, the second scoring device configured to produce a second score line while in the engaged position and traversed in a second scoring direction opposite the first scoring direction.

8. A glass manufacturing apparatus, comprising:
a forming body configured to form a glass ribbon;
a glass scoring apparatus positioned below the forming body, the glass scoring apparatus comprising:
a frame;
a cross-member assembly comprising a movable scoring unit, the movable scoring unit comprising a first scoring device configured to score the glass ribbon in a first scoring direction and a second scoring device configured to score the glass ribbon in a second scoring direction opposite the first scoring direction.

9. The glass manufacturing apparatus according to claim 8, further comprising at least four drive assemblies mounted on the frame, each drive assembly of the at least four drive assemblies comprising:
a threaded shaft;
a drive motor coupled to the threaded shaft and configured to rotate the threaded shaft; and
a ball nut assembly engaged with threads of the threaded shaft and coupled to the cross-member assembly.

10. The glass manufacturing apparatus according to claim 9, wherein each drive motor of the four drive assemblies is coupled to the respective threaded shaft by a reducing gear assembly.

11. The glass manufacturing apparatus according to claim 10, wherein a reduction ratio of each reducing gear assembly of the four drive assemblies is in a range from 4:1 to 2:1.

12. The glass manufacturing apparatus according to claim 8, wherein the first scoring device is coupled to a first articulated linkage and the second scoring is coupled to a second articulated linkage.

13. A method of manufacturing a glass sheet comprising:
drawing a glass ribbon from a forming body, the glass ribbon extending adjacent a cross-member assembly in a draw direction at a draw speed V, the cross-member assembly comprising a movable scoring unit coupled thereto, the scoring unit comprising a first scoring device and a second scoring device;
moving the cross-member assembly from a first vertical position in the draw direction at the draw speed V;
forming a first score line in the glass ribbon, the forming the first score line comprising engaging the first scoring device with the glass ribbon and moving the scoring unit in a first scoring direction;
removing a first glass sheet from the glass ribbon below the first score line;
forming a second score line in the glass ribbon above the first score line, the forming the second score line comprising engaging the second scoring device with the glass ribbon and moving the scoring unit in a second scoring direction opposite the first scoring direction; and
removing a second glass sheet from the glass ribbon below the second score line.

14. The method according to claim 13, wherein after the removing the first glass sheet and before the forming the second score line, moving the cross-member assembly back to the first vertical position.

15. The method according to claim 13, wherein the forming the first score line comprises moving the scoring unit in the first scoring direction from a first initial position to a first start position spaced apart from the first initial position, engaging the glass ribbon with the first scoring device from the first start position, and moving the scoring unit in the first scoring direction to a first stop position spaced apart from the first start position.

16. The method according to claim 15, further comprising stopping the scoring unit at the first stop position, disengaging the first scoring device from the glass ribbon at the first stop position, and moving the scoring unit in the first scoring direction from the first stop position to a second initial position spaced apart from the first stop position.

17. The method according to claim 16, wherein forming the second score line comprises moving the scoring unit in the second scoring direction from the second initial position to a second start position spaced apart from the second initial position, engaging the glass ribbon with the second scoring device from the second start position, and moving the scoring unit in the second scoring direction to a second stop position spaced apart from the second start position.

18. The method according to claim 17, further comprising, stopping the scoring unit at the second stop position, disengaging the second scoring device from the glass ribbon at the second stop position, and moving the scoring unit in the second scoring direction from the second stop position to the first initial position.

19. The method according to claim 14, wherein the moving the cross-member assembly back to the first vertical position comprises moving the cross-member assembly at a speed greater than V.
